(19) United States
(12) Patent Application Publication
(10) Pub. No.: US 2026/0067160 A1
(43) Pub. Date: Mar. 5, 2026

(54) MANAGEMENT DEVICE, FUNCTION UNIT, VEHICLE-MOUNTED COMMUNICATION SYSTEM, AND VEHICLE COMMUNICATION MANAGEMENT PROGRAM

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP); TOYOTA JIDOSHA KABUSHIKI KAISHA, Toyota-shi, Aichi (JP)

(72) Inventors: Ryo YAMANE, Osaka-shi (JP); Tatsuya IZUMI, Osaka-shi (JP); Hideyuki TANAKA, Osaka-shi (JP); Yusuke YAMAMOTO, Osaka-shi (JP); Yoshio ITO, Osaka-shi (JP); Kenta OGATA, Osaka-shi (JP); Makoto CHUJO, Osaka-shi (JP); Yoshitaka KIKUCHI, Yokkaichi-shi (JP); Darmawan GO, Yokkaichi-shi (JP); Hirofumi URAYAMA, Yokkaichi-shi (JP); Hideki GOTO, Toyota-shi (JP); Yasuhiro YAMASAKI, Toyota-shi (JP); Ikuyoshi OTAKE, Toyota-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP); TOYOTA JIDOSHA KABUSHIKI KAISHA, Toyota-shi, Aichi (JP)

(21) Appl. No.: 18/997,685

(22) PCT Filed: Jun. 9, 2023
(86) PCT No.: PCT/JP2023/021484

§ 371 Date: Jan. 22, 2025

(30) Foreign Application Priority Data
Aug. 2, 2022 (JP) 2022-123579

(51) Int. Cl. H04L 41/082; G06F 8/65; H04L 12/28

(52) U.S. Cl. CPC H04L 41/082; G06F 8/65; H04L 12/28

(57) ABSTRACT

A management device for use in a vehicle-mounted network that includes at least one vehicle-mounted function unit, the management device includes: a detection unit configured to detect addition of a function unit to the vehicle-mounted network; a determination unit configured to determine whether or not the vehicle-mounted function unit satisfies a requirement for the vehicle-mounted function unit and a new function unit being the function unit whose addition has been detected by the detection unit to communicate, based on requirement information transmitted from the new function unit and indicating the requirement; and an update request unit configured to transmit update request information requesting updating of the vehicle-mounted function unit to an external device other than the vehicle-mounted function unit, if the determination unit determines that the vehicle-mounted function unit does not satisfy the requirement.

### TECHNICAL FIELD

The present disclosure relates to a management device, a function unit, a vehicle-mounted communication system, and a vehicle communication management program.

This application is based upon and claims the benefit of priority from Japanese patent application No. 2022-123579 filed on Aug. 2, 2022 the disclosure of which is incorporated herein in their entirety by reference.

### BACKGROUND ART

Patent Document 1 (JP 2017-220220A) discloses the following vehicle electronic control device. That is, the vehicle electronic control device is a vehicle electronic control device (1 to 5) that is connected to a vehicle-mounted network (6) and executes a predetermined function by means of an installed application, and includes: a service interface (8) configured to make a request for a service that uses a function installed in another vehicle electronic control device connected to the vehicle-mounted network in response to a request from the application, and to respond to a request for a service from the other vehicle electronic control device by generating the service; a service bus (9) configured to transmit and receive messages corresponding to a request for a service and a response according to a predetermined protocol to and from the service interface of the other vehicle electronic control device; and a service management unit (11) configured to dynamically enable the service by managing the location of the service.

### CITATION LIST

### Patent Document

Patent Document 1: JP 2017-220220A

### SUMMARY OF THE INVENTION

A management device according to the present disclosure is a management device for use in a vehicle-mounted network that includes at least one vehicle-mounted function unit, the management device including: a detection unit configured to detect addition of a function unit to the vehicle-mounted network; a determination unit configured to determine whether or not the vehicle-mounted function unit satisfies a requirement for the vehicle-mounted function unit and a new function unit being the function unit whose addition has been detected by the detection unit to communicate, based on requirement information transmitted from the new function unit and indicating the requirement; and an update request unit configured to transmit update request information requesting updating of the vehicle-mounted function unit to an external device other than the vehicle-mounted function unit, if the determination unit determines that the vehicle-mounted function unit does not satisfy the requirement.

One aspect of the present disclosure can be realized not only as a management device that includes such characteristic processing units, but also as a method for carrying out such characteristic processing as steps, or a semiconductor integrated circuit that realizes a part or the entirety of the management device. One aspect of the present disclosure can be realized as a method including steps performed by a functional unit, or a semiconductor integrated circuit that realizes a part or the entirety of the functional unit.

### BRIEF DESCRIPTION OF THE DRAWINGS

FIG. 1 is a diagram showing a configuration of a communication system according to an embodiment of the present disclosure.

FIG. 2 is a diagram showing a configuration of a vehicle-mounted communication system according to the embodiment of the present disclosure.

FIG. 3 is a diagram showing a configuration of the relay device according to the embodiment of the present disclosure.

FIG. 4 is a diagram showing a configuration of the new network in the vehicle-mounted communication system according to the embodiment of the present disclosure.

FIG. 5 is a diagram showing an example of version information regarding software embedded in a vehicle-mounted ECU in a vehicle-mounted network according to a comparative example.

FIG. 6 is a diagram showing a configuration of a new function unit according to the embodiment of the present disclosure.

FIG. 7 is a diagram showing an example of a sequence of new network construction processing in the vehicle-mounted communication system according to the embodiment of the present disclosure.

FIG. 8 is a diagram showing another example of a sequence of new network construction processing in the vehicle-mounted communication system according to the embodiment of the present disclosure.

### DESCRIPTION OF EMBODIMENTS

There is a demand for a technology that enables various function units to be added to the vehicle-mounted network according to user needs.

### Problem to be Solved by the Present Disclosure

However, if function units in a vehicle-mounted network before a new function unit is added thereto do not support communication with the added function unit, communication between the function units may fail or become impossible.

The present disclosure has been made to solve the foregoing problem, and aims to provide a management device, a function unit, a vehicle-mounted communication system, and a vehicle communication management program that enable function units to communicate with each other more reliably in a vehicle-mounted network having a new configuration.

### Effects of the Present Disclosure

With the present disclosure, the function units can communicate with each other more reliably in the vehicle-mounted network having a new configuration.

### DESCRIPTION OF EMBODIMENT OF PRESENT DISCLOSURE

First, the details of an embodiment of the present disclosure are listed and described.

(1) A management device according to an embodiment of the present disclosure is a management device for use in a vehicle-mounted network that includes at least one vehicle-mounted function unit, the management device including: a detection unit configured to detect addition of a function unit to the vehicle-mounted network; a determination unit configured to determine whether or not the vehicle-mounted function unit satisfies a requirement for the vehicle-mounted function unit and a new function unit being the function unit whose addition has been detected by the detection unit to communicate, based on requirement information transmitted from the new function unit and indicating the requirement; and an update request unit configured to transmit update request information requesting updating of the vehicle-mounted function unit to an external device other than the vehicle-mounted function unit, if the determination unit determines that the vehicle-mounted function unit does not satisfy the requirement.

With this configuration, when addition of a new function unit to the vehicle-mounted network is detected, the management device can update the vehicle-mounted function unit so as to be capable of communicating with the new function unit. Thus, the function units can communicate with each other more reliably in the vehicle-mounted network having a new configuration.

(2) In the above (1), a configuration is possible in which, the management device further including: an acquisition unit configured to acquire, from the vehicle-mounted function unit, function unit information regarding the vehicle-mounted function unit for determining the requirement if the requirement information is received from the new function unit, wherein the determination unit determines whether or not the vehicle-mounted function unit satisfies the requirement based on the requirement information and the function unit information.

With this configuration, for example, latest function unit information can be considered when it is determined whether or not the vehicle-mounted function unit supports communication with the new function unit, thereby improving the determination accuracy of the determination unit. Further, function unit information regarding the vehicle-mounted function unit need not be acquired from, for example, an external device outside the vehicle-mounted network. This can simplify the processing for acquiring the function unit information.

(3) In the above (1), a configuration is possible in which, the management device further including: an acquisition unit configured to acquire, from the external device, function unit information regarding the vehicle-mounted function unit for determining the requirement, wherein the determination unit determines whether or not the vehicle-mounted function unit satisfies the requirement based on the requirement information and the function unit information.

With this configuration, for example, latest function unit information can be considered when it is determined whether or not the vehicle-mounted function unit supports communication with the new function unit, thereby improving the determination accuracy of the determination unit. Further, function unit information regarding the vehicle-mounted function unit in the vehicle-mounted network can be acquired from this vehicle-mounted function unit, and this function unit information can be acquired.

(4) In any of the above (1) to (3), a configuration is possible in which, the requirement is that a version of software embedded in the vehicle-mounted function unit is the same as a version of software embedded in the new function unit, or that the version of the software embedded in the vehicle-mounted function unit is newer than the version of the software embedded in the new function unit.

With this configuration, software embedded in the vehicle-mounted function unit can be updated to an appropriate state so that the vehicle-mounted function unit and the new function unit can communicate with each other.

(5) A function unit according to an embodiment of the present disclosure is a function unit for use in a vehicle-mounted network that includes at least one vehicle-mounted function unit, the function unit including: a processing unit configured to transmit, to a management device in the vehicle-mounted network, requirement information indicating a requirement for communicating with the vehicle-mounted function unit, in response to the function unit being added to the vehicle-mounted network.

With this configuration, when a function unit is added to the vehicle-mounted network, the management device can acquire the requirement information from this function unit, and can therefore determine whether or not the vehicle-mounted function unit satisfies the requirement included in the requirement information. Further, when the vehicle-mounted function unit does not satisfy the requirement, the management device can perform various types of processing necessary for the added function unit to normally communicate with the vehicle-mounted function unit. Thus, the function units can communicate with each other more reliably in the vehicle-mounted network having a new configuration.

(6) A vehicle-mounted communication system according to an embodiment of the present disclosure includes: a management device for use in a vehicle-mounted network that includes at least one vehicle-mounted function unit; and a function unit, wherein the management device detects addition of the function unit to the vehicle-mounted network, a new function unit being the function unit whose addition to the vehicle-mounted network has been detected transmits requirement information to the management device, the requirement information being information indicating a requirement for the vehicle-mounted function unit and the new function unit to communicate, the management device determines whether or not the vehicle-mounted function unit satisfies the requirement based on the requirement information received from the new function unit, and if the management device determines that the vehicle-mounted function unit does not satisfy the requirement, the management device transmits update request information requesting updating of the vehicle-mounted function unit to an external device other than the vehicle-mounted function unit.

With this configuration, when addition of a new function unit to the vehicle-mounted network is detected, the management device can update the vehicle-mounted function unit so as to be capable of communicating with the new function unit. Thus, the function units can communicate with each other more reliably in the vehicle-mounted network having a new configuration.

(7) A vehicle communication management program according to an embodiment of the present disclosure is a vehicle communication management program to be used by a management device for use in a vehicle-mounted network that includes at least one vehicle-mounted function unit, the vehicle communication management program for causing a computer to function as: a detection unit configured to detect addition of a function unit to the vehicle-mounted network; a determination unit configured to determine whether or not the vehicle-mounted function unit satisfies a requirement for the vehicle-mounted function unit and a new function unit being the function unit whose addition has been detected by the detection unit to communicate, based on requirement information transmitted from the new function unit and indicating the requirement; and an update request unit configured to transmit update request information requesting updating of the vehicle-mounted function unit to an external device other than the vehicle-mounted function unit, if the determination unit determines that the vehicle-mounted function unit does not satisfy the requirement.

With this configuration, when addition of a new function unit to the vehicle-mounted network is detected, the management device can update the vehicle-mounted function unit so as to be capable of communicating with the new function unit. Thus, the function units can communicate with each other more reliably in the vehicle-mounted network having a new configuration.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### [Communication System]

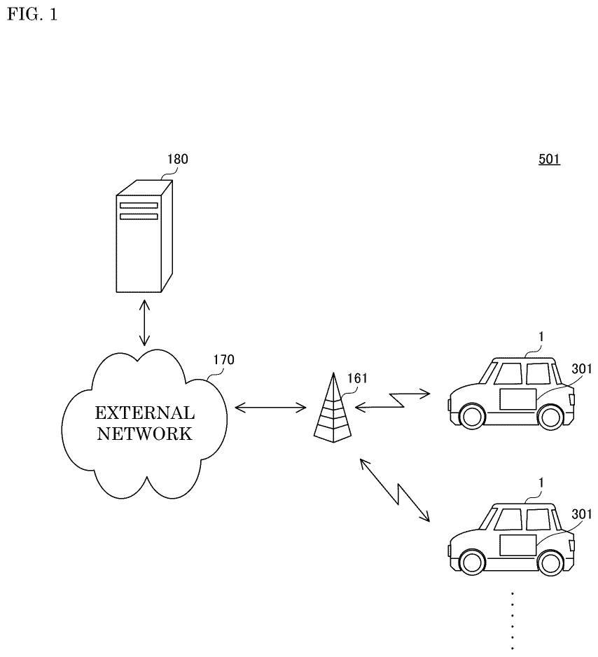

FIG. 1 is a diagram showing a configuration of a communication system according to an embodiment of the present disclosure.

Referring to FIG. 1, a communication system 501 includes a server 180 and one or more vehicle-mounted communication system 301. Each vehicle-mounted communication system 301 is installed in a vehicle 1.

### [Vehicle-Mounted Communication System]

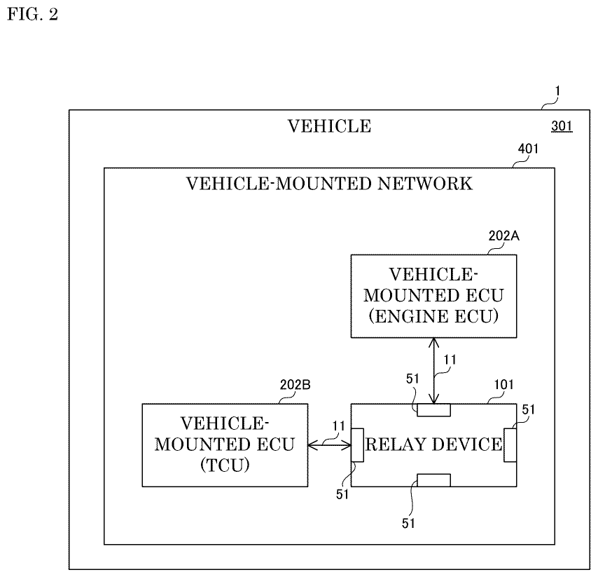

FIG. 2 is a diagram showing a configuration of a vehicle-mounted communication system according to the embodiment of the present disclosure.

Referring to FIG. 2, the vehicle-mounted communication system 301 includes, for example, one or more vehicle-mounted ECUs (Electronic Control Units) 202, and one or more relay devices 101.

In the example shown in FIG. 2, the vehicle-mounted communication system 301 includes vehicle-mounted ECUs 202A and 202B, which are the vehicle-mounted ECUs 202, and one relay device 101. The vehicle-mounted ECUs 202 and the relay device 101 constitute a vehicle-mounted network 401. Each vehicle-mounted ECU 202 is an example of a vehicle-mounted function unit that is installed in the vehicle 1. The relay device 101 is an example of a management device.

Note that the vehicle-mounted communication system 301 is not limited to including two vehicle-mounted ECUs, and may alternatively include one vehicle-mounted ECU 202 or three or more vehicle-mounted ECUs 202. Further, the vehicle-mounted communication system 301 is not limited to including one relay device 101, and may alternatively include a plurality of relay devices 101.

In the vehicle-mounted network 401, the vehicle-mounted ECUs 202 are connected to the relay device 101, for example via Ethernet (registered trademark) cables 11.

More specifically, the relay device 101 includes a plurality of communication ports 51. The communication ports 51 are, for example, terminals to which the Ethernet cables 11 can be connected. The relay device 101 and the vehicle-mounted ECUs 202 are each connected to another vehicle-mounted ECU 202 via the communication port 51 and the Ethernet cable 11.

The relay device 101 is used in the vehicle-mounted network 401 that includes a plurality of vehicle-mounted ECUs 202. The relay device 101 is, for example, a gateway device and is capable of relaying data between a plurality of vehicle-mounted ECUs 202 connected thereto. The relay device 101 can perform relay processing in accordance with Layer 2 and Layer 3, which is a higher-level layer than Layer 2, for example.

More specifically, the relay device 101 performs relay processing for frames communicated between the vehicle-mounted ECUs 202 connected thereto via the Ethernet cables 11, in accordance with, for example, the Ethernet communication standard.

Note that the vehicle-mounted communication system 301 is not limited to a configuration in which relay processing for frames is performed in accordance with the Ethernet communication standard. For example, it is also possible to employ a configuration in which, for example, relay processing for frames is performed in accordance with a communication standard such as CAN (Controller Area Network), CAN FD (CAN with Flexible Data Rate), FlexRay (registered trademark), MOST (Media Oritend System Transport)(registered trademark), or LIN (Local Interconnect Network).

The relay device 101 and the vehicle-mounted ECUs 202 each generate a frame that includes various types of information, which will be described later, and transmits the generated frame to another vehicle-mounted ECU 202 or relay device 101.

Each vehicle-mounted ECU 202 is, for example, a TCU (Telematics Communication Unit), an autonomous driving ECU, an engine ECU, a sensor, a navigation device, a human machine interface, a camera, or the like.

In this example, the vehicle-mounted ECU 202A and the vehicle-mounted ECU 202B are an engine ECU and a TCU, respectively.

Hereinafter, the vehicle-mounted ECU 202A and the vehicle-mounted ECU 202B are also referred to as an engine ECU 202A and a TCU 202B, respectively.

The engine ECU 202A is capable of communicating with the TCU 202B via the relay device 101, and controls an engine of the vehicle 1, for example.

More specifically, the engine ECU 202A acquires information indicating, for example, the engine speed, the vehicle speed of the vehicle 1, the engine shaft torque, the state of a transmission, the state of a throttle valve, and measurement values of sensors, and controls the engine based on the acquired information.

The engine ECU 202A is capable of transmitting a part or all of the acquired information to the relay device 101 in response to a request from the relay device 101, for example.

Referring to FIGS. 1 and 2, the TCU 202B is capable of communicating with the server 180. Specifically, the TCU 202B is capable of communicating with the server 180 via a wireless base station device 161 using IP packets, for example.

More specifically, the TCU 202B is capable of wirelessly communicating with the wireless base station device 161 in accordance with a communication standard such as LTE (Long Term Evolution) or 5G.

Specifically, when the wireless base station device 161 receives an IP packet from the server 180 via an external network 170, such as the internet, the wireless base station device 161 includes the received IP packet in a wireless signal and transmits this signal to the TCU 202B.

When the TCU 202B receives from the wireless base station device 161 the wireless signal including the IP packet from the server 180, the TCU 202B acquires the IP packet from the received wireless signal, stores the acquired IP packet in an Ethernet frame, and transmits this Ethernet frame to the relay device 101.

When the TCU 202B receives the Ethernet frame from the relay device 101, the TCU 202B acquires the IP packet from the received Ethernet frame, includes the acquired IP packet in a wireless signal, and transmits this wireless signal to the wireless base station device 161.

When the wireless base station device 161 receives the wireless signal from the TCU 202B, the wireless base station device 161 acquires the IP packet from the received wireless signal and transmits the acquired IP packet to the server 180 via the external network 170.

The server 180 is, for example, an OTA (Over The Air) server and is provided outside the vehicle 1. The server 180 is an example of an external device different from the vehicle-mounted function unit. The server 180 holds an update program for updating software embedded in the vehicle-mounted ECUs 202. As will be described later, the server 180 transmits the update program to a designated vehicle-mounted ECU 202 in response to a request from the relay device 101.

### [Relay Device]

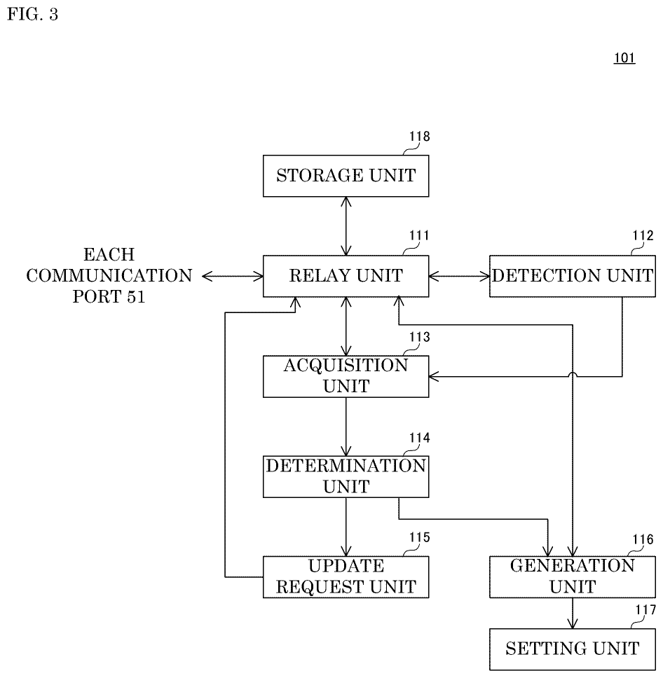

FIG. 3 is a diagram showing a configuration of the relay device according to the embodiment of the present disclosure.

Referring to FIG. 3, the relay device 101 includes a relay unit 111, a detection unit 112, an acquisition unit 113, a determination unit 114, an update request unit 115, a generation unit 116, a setting unit 117, and a storage unit 118.

Some or all of the relay unit 111, the detection unit 112, the acquisition unit 113, the determination unit 114, the update request unit 115, the generation unit 116, and the setting unit 117 are realized by, for example, a circuitry including one or more processors. The storage unit 118 is, for example, a nonvolatile memory included in the circuitry.

The relay unit 111 relays frames transmitted and received between the vehicle-mounted ECUs 202. Specifically, when the relay unit 111 receives a frame from one vehicle-mounted ECU 202, the relay unit 111 transmits the received frame to a destination vehicle-mounted ECU 202.

Also, when the relay unit 111 receives a frame addressed to the relay device 101 that includes the relay unit 111 itself from a function unit that is newly added to the vehicle-mounted network 401, the relay unit 111 outputs the received frame to the detection unit 112.

Hereinafter, the function unit newly added to the vehicle-mounted network 401 is also referred to as a new function unit, the vehicle-mounted network 401 that includes the new function unit is also referred to as a new network, and the vehicle-mounted network 401 before the new function unit is added thereto is also referred to as an existing network. A function unit included in the existing network is also referred to as an existing function unit.

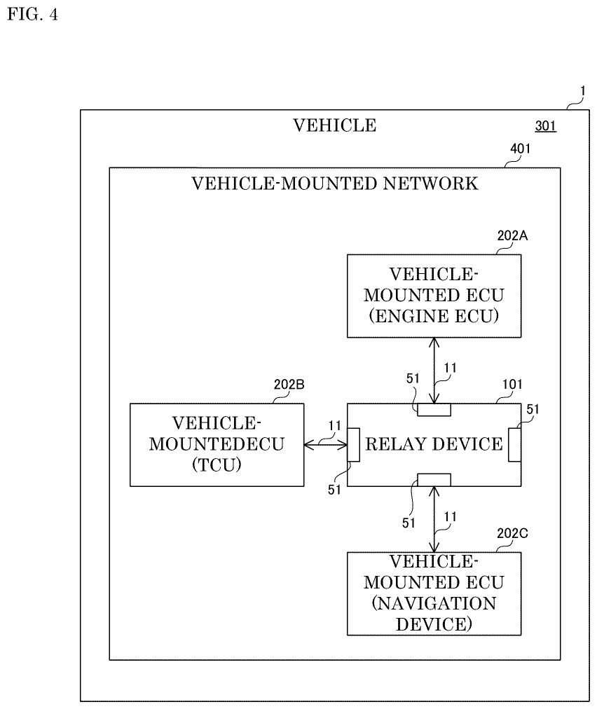

FIG. 4 is a diagram showing a configuration of the new network in the vehicle-mounted communication system according to the embodiment of the present disclosure. FIG. 4 shows a configuration of a vehicle-mounted network 401, which is the vehicle-mounted network 401 shown in FIG. 2 to which a vehicle-mounted ECU 202C is newly added.

Referring to FIG. 4, the vehicle-mounted ECU 202C is connected to the communication port 51 of the relay device 101, for example via the Ethernet cable 11. In this example, the vehicle-mounted ECU 202C is a navigation device. Hereinafter, the vehicle-mounted ECU 202C is also referred to as a navigation device 202C.

Referring again to FIG. 3, the detection unit 112 of the relay device 101 detects the addition of anew function unit to the vehicle-mounted network 401. Here, the detection unit 112 detects the vehicle-mounted ECU 202C.

The detection unit 112 receives a frame from the vehicle-mounted ECU 202C via the relay unit 111, and performs processing to authenticate the vehicle-mounted ECU 202C using an ID and an authentication password that are included in the frame.

If the vehicle-mounted ECU 202C is successfully authenticated, the detection unit 112 transmits a frame that includes successful authentication information indicating that the authentication is successful, to the vehicle-mounted ECU 202C via the relay unit 111.

When a new function unit is successfully authenticated as described above, the detection unit 112 outputs a frame that includes detection information indicating, for example, an ID of the new function unit to the acquisition unit 113.

Note that the detection unit 112 may also be configured to, for example, periodically broadcast a search message for detecting a new function unit via the relay unit 111. In this case, the new function unit receives the search message and transmits connection request information in response to the received search message.

The detection unit 112 may also be configured to add, as a new function unit, an application that is installed in an existing vehicle-mounted ECU 202 in the vehicle-mounted network 401. That is, anew function unit may be hardware or software.

Hereinafter, software that realizes an application in a vehicle-mounted ECU 202 is also referred to simply as “software”.

### [Problem]

Here, if an existing function unit in a new network does not support communication with a new function unit, there is a possibility that the function units cannot normally communicate with each other.

For example, in FIG. 4, if software (hereinafter also referred to as “existing software”) embedded in the vehicle-mounted ECU 202B, which is an example of the existing function unit, does not support communication with software (hereinafter also referred to as “new software”) embedded in the vehicle-mounted ECU 202C, which is the new function unit, there is a possibility that communication between the vehicle-mounted ECU 202C and the vehicle-mounted ECU 202B will malfunction or become impossible.

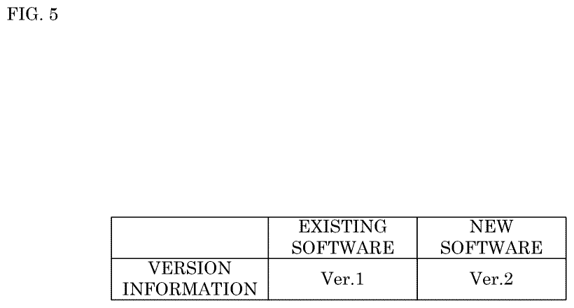

FIG. 5 is a diagram showing an example of version information regarding software embedded in a vehicle-mounted ECU in a vehicle-mounted network according to a comparative example.

In the example of FIG. 5, the version of the existing software is “Ver. 1” and the version of the new software is “Ver. 2”. If the version of the existing software is older than the version of the new software in this way, there is a possibility that normal communication cannot be ensured in the new network.

In this regard, the vehicle-mounted communication system according to the embodiment of the present disclosure solves the above problem by the following configuration and operations.

### [New Function Unit]

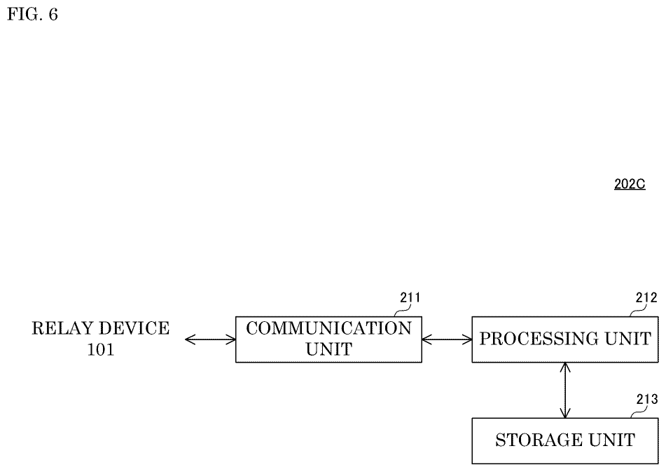

FIG. 6 is a diagram showing a configuration of a new function unit according to the embodiment of the present disclosure. FIG. 6 shows a configuration of the vehicle-mounted ECU 202C shown in FIG. 4.

Referring to FIG. 6, the vehicle-mounted ECU 202C includes a communication unit 211, a processing unit 212, and a storage unit 213. One or both of the communication unit 211 and the processing unit 212 are realized by, for example, a circuitry including one or more processors. The storage unit 213 is, for example, a nonvolatile memory included in the circuitry.

When the communication unit 211 receives a frame addressed to the vehicle-mounted ECU 202C that includes the communication unit 211 itself from the relay device 101 or another vehicle-mounted ECU 202, the communication unit 211 outputs the received frame to the processing unit 212.

The processing unit 212 performs various types of processing based on information included in the frame received from the communication unit 211. For example, when the processing unit 212 receives successful authentication information from the relay device 101, the processing unit 212 transmits requirement information indicating a requirement necessary for communicating with the other function unit to the relay device 101.

More specifically, the processing unit 212 transmits a frame that includes requirement information for communicating with the existing function unit to the relay device 101 via the communication unit 211. Here, it is assumed that the processing unit 212 transmits to the relay device 101 a frame that includes requirement information for communicating with the vehicle-mounted ECU 202B.

The requirement information includes, for example, version information regarding the existing software and version information regarding the new software that relates to the requirement for communication between the existing function unit and the new function unit.

The requirement (hereinafter also referred to as a “requirement R”) included in the requirement information is, for example, that the version of the existing software and the version of the new software are the same. Specifically, the requirement R is, for example, that the version of the software embedded in the vehicle-mounted ECU 202B is the same as the version of the software embedded in the vehicle-mounted ECU 202C.

Note that the requirement R may alternatively be that the version of the existing software is newer than the version of the new software.

Also, the requirement R may be a requirement indicating settings of a communication action required of the existing function unit. For example, the requirement R may be, for example, a requirement for the communication bandwidth of the existing function unit, and a requirement for the transmission period of information that the existing function unit transmits to the new function unit.

The requirement information may also be information indicating specifications of the new function unit. More specifically, the requirement information may be information indicating the content of a service provided by the new function unit.

If the requirement information is information indicating the content of a service requested by the new function unit, the requirement R may be that the new function unit receives a frame that includes information indicating that the service can be provided, from the existing function unit within a predetermined time period.

### [Acquisition Unit]

Referring to FIGS. 1 and 3, the acquisition unit 113 of the relay device 101 acquires the requirement information regarding the new function unit and the function unit information regarding the existing function unit.

More specifically, if the acquisition unit 113 receives the requirement information from the new function unit whose addition has been detected by the detection unit 112, the acquisition unit 113 acquires the function unit information regarding the existing function unit from this existing function unit in order to determine the requirement R. When the acquisition unit 113 receives detection information from the detection unit 112, the acquisition unit 113 transmits information request notification for requesting requirement information to the new function unit via the relay unit 111. When the acquisition unit 113 receives the requirement information from the new function unit via the relay unit 111, the acquisition unit 113 transmits an information request notification for requesting function unit information to the existing function unit via the relay unit 111.

The acquisition unit 113 acquires, for example, version information regarding the existing software as the function unit information regarding the existing function unit. The acquisition unit 113 outputs the requirement information received from the new function unit and the function unit information received from the existing function unit to the determination unit 114. Note that when the acquisition unit 113 receives the requirement information from the new function unit, the acquisition unit 113 may acquire the function unit information regarding the existing function unit from the server 180.

### [Determination Unit]

The determination unit 114 determines whether or not the existing function unit satisfies the requirement R based on the requirement information transmitted from the new function unit.

More specifically, the determination unit 114 determines whether or not the existing function unit satisfies the requirement R based on the requirement information and the function unit information received from the acquisition unit 113. For example, the determination unit 114 determines that the existing function unit does not satisfy the requirement R if the version of the existing software is older than the version of the new software, as shown in FIG. 5 described above. If the determination unit 114 determines that the existing function unit does not satisfy the requirement R, the determination unit 114 outputs, to the update request unit 115, information indicating that the determination result is negative (hereinafter also referred to as “negative determination information”).

On the other hand, if the determination unit 114 determines that the existing function unit satisfies the requirement R, the determination unit 114 outputs, to the generation unit 116, information indicating that the determination result is positive (hereinafter also referred to as “positive determination information”).

### [Update Request Unit]

Referring to FIGS. 1, 2, and 3, if the determination unit 114 determines that the existing function unit does not satisfy the requirement R, the update request unit 115 transmits update request information to request updating of the existing function unit to an external device via the relay unit 111 and the TCU 202B. More specifically, when the update request unit 115 receives the negative determination information from the determination unit 114, the update request unit 115 outputs the update request information to the relay unit 111. When the relay unit 111 receives the update request information from the update request unit 115, the relay unit 111 transmits an Ethernet frame in which this update request information is stored to the TCU 202B via the communication port 51.

When the TCU 202B receives the Ethernet frame from the relay unit 111, the TCU 202B acquires an IP packet from the received Ethernet frame, includes the acquired IP packet in a wireless signal, and transmits this wireless signal to the server 180 via the wireless base station device 161.

Note that the update request information may also include function unit information regarding the new function unit. For example, the Ethernet frame in which the update request information is stored may also include information designating the version to which the existing software is to be updated. The Ethernet frame may also include, as the information designating the version of the existing software after the updating, information indicating a version that is the same as the version of the new software or information indicating a version newer than the version of the new software.

When the server 180 receives the wireless signal including the IP packet from the TCU 202B, the server 180 transmits an IP packet including the update program for the existing software, an ID of the server 180 itself, and a MAC (Media Access Control) address of the existing function unit to be updated, to the wireless base station device 161 via the external network 170. Here, the MAC address of the existing function unit to be updated that is included in the IP packet is the MAC address of the TCU 202B.

When the wireless base station device 161 receives the IP packet from the server 180 via the external network 170, the wireless base station device 161 includes the received IP packet in a wireless signal and transmits this wireless signal to the TCU 202B.

When the TCU 202B receives the wireless signal including the IP packet from the wireless base station device 161, the TCU 202B acquires the IP packet from the received wireless signal, and installs the update program included in the IP packet. The existing software embedded in the TCU 202B can thus be updated.

When the software update is completed, the TCU 202B issues a predetermined notification to the other devices in the communication system 501. Specifically, the TCU 202B transmits an IP packet that includes an update completion notification indicating that the software update has been completed, to the server 180 via the wireless base station device 161. The TCU 202B also transmits an update completion notification to the relay device 101.

Note that the aforementioned external device in the communication system 501 is not limited to the server 180 outside the vehicle-mounted network 401, but may alternatively be, for example, a device (hereinafter also referred to as a “reprogramming device”) for reprogramming programs and the like embedded in the existing function unit. The relay device 101 is capable of communicating with the reprogramming device via a communication cable. That is, the relay device 101 may be connected to an external device in the vehicle-mounted network 401 not by a wireless line but by a wired line.

### [Generation Unit]

Referring again to FIG. 3, when the generation unit 116 of the relay device 101 receives the positive determination information from the determination unit 114 or receives the update completion notification from the existing function unit, the generation unit 116 acquires function unit information regarding the existing function unit and the function unit information regarding the new function unit. The generation unit 116 generates configuration information regarding the new network based on the function unit information regarding the existing function unit and the function unit information regarding the new function unit.

More specifically, the generation unit 116 acquires the function unit information regarding the existing function unit and the function unit information regarding the new function unit via the relay unit 111.

The generation unit 116 generates configuration information relating to the new network based on the acquired function unit information regarding the existing function unit and the acquired function unit information regarding the new function unit.

For example, the generation unit 116 acquires, as the function unit information, information from which the topology of hardware devices such as the vehicle-mounted ECUs 202 and the relay device 101 in the new network can be recognized. Also, for example, the generation unit 116 acquires information from which constraints regarding the placement of applications in the hardware devices in the new network can be recognized. Also, for example, the generation unit 116 acquires information from which constraints on the communication method in the new network can be recognized.

The generation unit 116 acquires, as information from which the topology of the hardware devices can be recognized, vehicle information indicating the manufacturer and model of the vehicle 1 in which the vehicle-mounted ECUs 202 and the relay device 101 are installed, additional option information indicating additional options installed in the vehicle 1, a vehicle-mounted device ID, which is an identifier indicating the manufacturer, serial number, and so on, of each vehicle-mounted ECU 202, a port number of each communication port for connection between the hardware devices, and information regarding the bandwidth of each communication path between the hardware devices, for example.

The generation unit 116 acquires, as information from which constraints regarding the placement of applications in the hardware devices can be recognized, at least one of the following types of information: i.e., information regarding calculation speed required for execution; memory usage; OS (Operating System) environment constraints; and constraints on the communication protocols, such as TCP (Transmission Control Protocol) and UDP (User Datagram Protocol), regarding each application in the vehicle-mounted ECUs 202, for example.

The generation unit 116 acquires, as information from which constraints on the communication method in the new network can be recognized, at least one of the following types of information: i.e., information relating to a messaging method indicating communication data size, communication frequency, whether burst transmission is required, allowable delay time, allowable amount of loss, the required security level, a communication type indicating operation timing, such as whether communication is periodic or irregular, an identifier of an application to be a communication partner, and a request-response type/a publish-subscribe type, or the like, of each application in the vehicle-mounted ECUs 202; and information relating to the priority of communication performed by each application.

For example, the generation unit 116 specifies one or more types of function unit information that are necessary for setting information for the new network out of the aforementioned types of function unit information.

The generation unit 116 transmits an information request notification for requesting function unit information of the specified type to the existing function unit and the new function unit via the relay unit 111.

The existing function unit and the new function unit transmit their own function unit information of the type designated in the information request notification, for example, to the generation unit 116 in response to the information request notification received from the generation unit 116.

When the generation unit 116 receives the function unit information regarding the existing function unit and the function unit information regarding the new function unit via the relay unit 111, the generation unit 116 generates setting information for the new network based on the received function unit information.

More specifically, the generation unit 116 generates, as the setting information, information from which the vehicle 1 and the function units in the new network can be specified.

More specifically, the generation unit 116 generates setting information indicating settings of the relay device 101 for performing communication in the new network.

For example, based on the acquired function unit information regarding the existing function unit and the acquired function unit information regarding the new function unit, the generation unit 116 generates setting information indicating settings of the relay device 101 for the function units and the relay device 101 in the new network to communicate, such as filtering, communication bandwidth, and VLAN (Virtual Local Area Network) settings in the relay device 101. The generation unit 116 outputs the setting information to the setting unit 117. Note that the acquisition unit 113 is not limited to being configured to acquire version information regarding the existing software as the function unit information for determining the requirement R, and may alternatively be configured to acquire function unit information such as the aforementioned information.

### [Setting Unit]

When the setting unit 117 is notified of the settings by the generation unit 116, the setting unit 117 changes various settings in accordance with the notified settings.

Note that the generation unit 116 may also be configured to generate setting information further indicating settings of the existing function unit and the new function unit, and notify the existing function unit and the new function unit of settings for performing communication in the new network based on the setting information.

The function units and the relay device 101 in the new network communicate with each other in accordance with the changed settings.

Note that the relay device 101 is not limited to being configured to transmit the update request information to the server 180, and may also be configured to transmit the update request information to an external device such as a display device within the vehicle-mounted network 401. For example, the relay device 101 may transmit the update request information to the navigation device 202C in the vehicle-mounted network 401 shown in FIG. 4. When the navigation device 202C receives the update request information, the navigation device 202C displays, for example, a message prompting updating of the existing function unit on the screen.

### [Operation Flow]

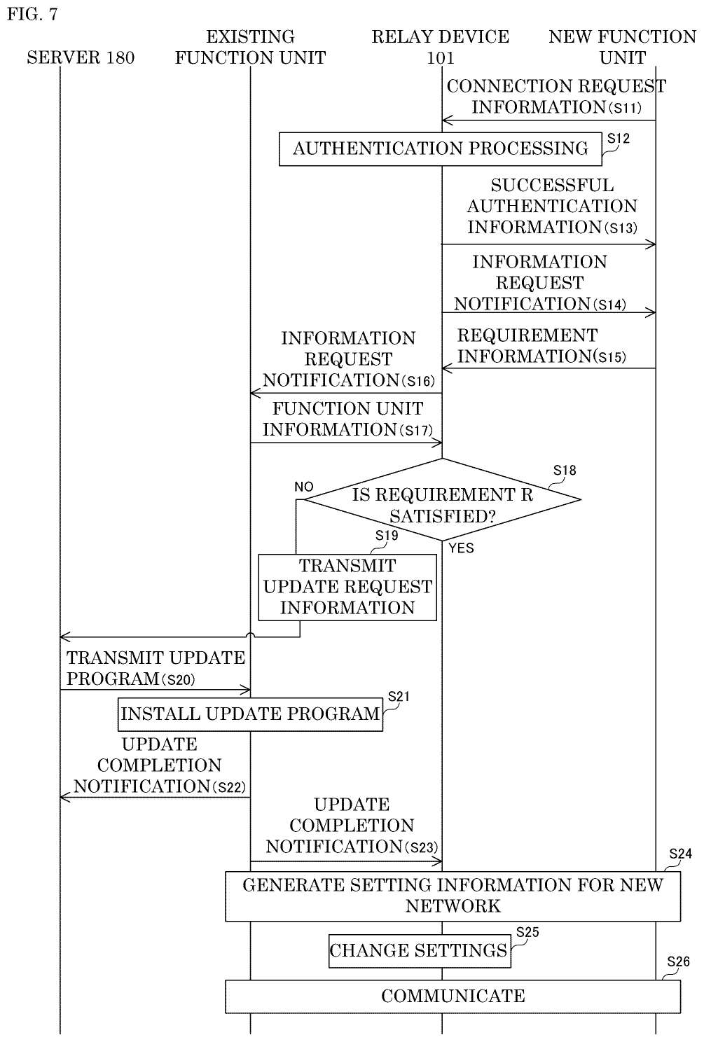

FIG. 7 is a diagram showing an example of a sequence of new network construction processing in the vehicle-mounted communication system according to the embodiment of the present disclosure.

Referring to FIG. 7, first, the new function unit transmits connection request information to the relay device 101 (step S11).

Next, upon receiving the connection request information, the relay device 101 detects the new function unit and performs processing to authenticate the new function unit (step S12).

Next, upon successfully authenticating the new function unit, the relay device 101 transmits successful authentication information to the new function unit (step S13).

Further, upon successfully authenticating the new function unit, the relay device 101 transmits an information request notification for requesting requirement information to the new function unit (step S14).

Next, the new function unit transmits the requirement information to the relay device 101 in response to the information request notification (step S15).

Next, upon receiving the requirement information from the new function unit, the relay device 101 transmits, to the existing function unit, an information request notification for requesting function unit information regarding the existing function unit (step S16).

Next, the existing function unit transmits its own function unit information to the relay device 101 in response to the information request notification. Here, the existing function unit transmits, as its own function unit information, version information regarding the existing software to the relay device 101 (step S17).

Next, the relay device 101 determines whether or not the existing function unit satisfies the requirement R based on the requirement information and the function unit information (step S18).

Next, if it is determined that the existing function unit does not satisfy the requirement R (“NO” in step S18), the relay device 101 transmits update request information to request updating of the existing software to the server 180 (step S19).

Next, the server 180 transmits, to the existing function unit, an update program including the version designated in the update request information from the relay device 101 (step S20).

Next, the existing function unit updates the existing software by installing the update program received from the server 180 (step S21), and when the update is completed, the existing function unit transmits an update completion notification to the server 180 (step S22).

Further, when the update of the existing software is completed, the existing function unit transmits an update completion notification to the relay device 101 (step S23).

Next, when the relay device 101 receives the update completion notification from the existing function unit, the relay device 101 generates setting information for the new network based on the function unit information regarding the existing function unit and the function unit information regarding the new function unit (step S24).

Next, the relay device 101 changes various settings of itself based on the generated setting information (step S25).

Next, the relay device 101, the new function unit, and the existing function unit in the new network communicate with each other in accordance with the changed settings (step S26).

On the other hand, if it is determined that the existing function unit satisfies the requirement R (“YES” in step S18), the relay device 101 performs processing in steps S24 to S26.

### <Variations>

In the above example, if the acquisition unit 113 of the relay device 101 receives requirement information from the new function unit whose addition has been detected by the detection unit 112, the acquisition unit 113 acquires function unit information regarding the existing function unit from this existing function unit. In the following example, the server 180 holds function unit information regarding the existing function unit in the existing network, and transmits the function unit information to the relay device 101. In other words, in the following example, the relay device 101 acquires the function unit information regarding the existing function unit from the server 180.

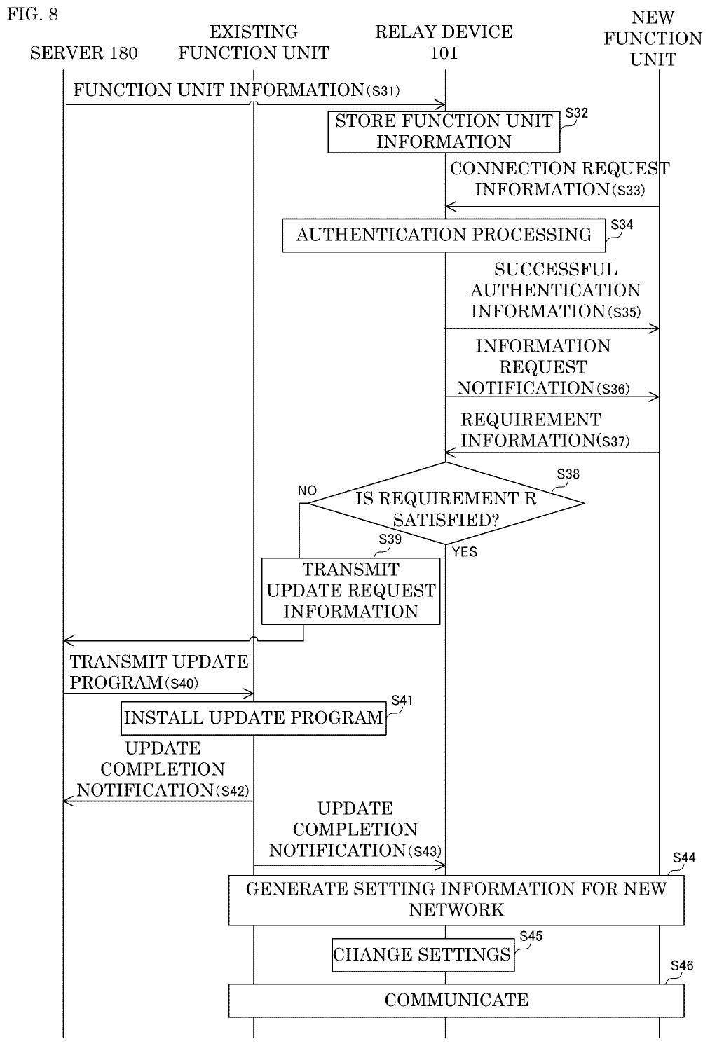

FIG. 8 is a diagram showing another example of a sequence of new network construction processing in the vehicle-mounted communication system according to the embodiment of the present disclosure.

Referring to FIGS. 3 and 8, first, the server 180 transmits the function unit information regarding the existing function unit to the relay device 101 periodically or irregularly. More specifically, the server 180 stores version information regarding the existing software as the function unit information. The server 180 transmits the version information to the relay device 101 when, for example, updating the existing software in the existing network. For example, if the existing network includes a plurality of existing function units, the server 180 transmits function unit information regarding each existing function unit to the relay device 101 (step S31).

Next, the relay device 101 stores the function unit information regarding the existing function unit received from the server 180 in the storage unit 118 (step S32).

Next, the new function unit transmits connection request information to the relay device 101 (step S33).

Next, upon receiving the connection request information, the relay device 101 detects the new function unit and performs processing to authenticate the new function unit (step S34).

Next, upon successfully authenticating the new function unit, the relay device 101 transmits successful authentication information to the new function unit (step S35).

Further, upon successfully authenticating the new function unit, the relay device 101 transmits an information request notification for requesting requirement information to the new function unit (step S36).

Next, the new function unit transmits requirement information to the relay device 101 in response to the information request notification (step S37).

Processing in steps S38 to S46 shown in FIG. 8 is the same as processing in steps S18 to S26 shown in FIG. 7.

Note that the management device according to the embodiment of the present disclosure is included in the relay device 101 in the vehicle-mounted communication system 301, but there is no limitation thereto. Some or all of the units in the relay device 101 other than the relay unit 111 may be included in a device other than the relay device 101 in the vehicle-mounted communication system 301, or may be provided outside the vehicle-mounted communication system 301.

Furthermore, the management device according to the embodiment of the present disclosure may alternatively be realized by a server (not shown) capable of communicating with the vehicle-mounted communication system 301. In this case, some or all of the functions of the management device according to the embodiment of the present disclosure may be provided by cloud computing. That is, the management device according to the embodiment of the present disclosure may be constituted by a plurality of cloud servers or the like.

Each type of processing (each function) in the above embodiment is realized by a circuitry including one or more processors. The circuitry may be constituted by an integrated circuit or the like that combines one or more memories, various analog circuits, and various digital circuits, in addition to the one or more processors. The one or more memories store programs (instructions) that cause the one or more processors to execute each type of the above processing. The one or more processors may execute each type of the above processing according to the programs read out from the one or more memories, or may execute each type of the above processing according to a logic circuit designed in advance to execute each type of the above processing. The processors may be various processors suitable for computer control, such as a CPU (Central Processing Unit), a GPU (Graphics Processing Unit), a DSP (Digital Signal Processor), an FPGA (Field Programmable Gate Array), and an ASIC (Application Specific Integrated Circuit). Note that a plurality of physically separated processors may cooperate with each other to execute each type of the above processing. For example, the processors installed in a plurality of physically separate computers may cooperate with each other via a network such as a LAN (Local Area Network), a WAN (Wide Area Network), or the internet to execute each type of the above processing. The above programs may be installed in the memories via the network from an external server device or the like, or may be distributed in a state stored on a recording medium such as a CD-ROM (Compact Disc Read Only Memory), a DVD-ROM (Digital Versatile Disk Read Only Memory), or semiconductor memory, and installed in the memories from the recording medium.

The foregoing embodiments are to be construed in all respects as illustrative and not restrictive. The scope of the present invention is defined by the claims rather than the description above, and is intended to include all modifications within the meaning and scope of the claims and equivalents thereof.

The above description includes characteristics described in the following supplementary notes.

### [Supplementary Note 1]

A management device for use in a vehicle-mounted network that includes at least one vehicle-mounted function unit, the management device including:
a detection unit configured to detect addition of a function unit to the vehicle-mounted network;
a determination unit configured to determine whether or not the vehicle-mounted function unit satisfies a requirement for the vehicle-mounted function unit and a new function unit being the function unit whose addition has been detected by the detection unit to communicate, based on requirement information transmitted from the new function unit and indicating the requirement; and
an update request unit configured to transmit update request information requesting updating of the vehicle-mounted function unit to an external device other than the vehicle-mounted function unit, if the determination unit determines that the vehicle-mounted function unit does not satisfy the requirement,
wherein the update request information includes function unit information regarding the new function unit.

### [Supplementary Note 2]

A management device for use in a vehicle-mounted network that includes at least one vehicle-mounted function unit, the management device including:
a processing circuit,
the processing circuit being configured to
   detect addition of a function unit to the vehicle-mounted network;
   determine whether or not the vehicle-mounted function unit satisfies a requirement for the vehicle-mounted function unit and a new function unit being the function unit whose addition has been detected by the detection unit to communicate, based on requirement information transmitted from the new function unit and indicating the requirement; and
transmit update request information requesting updating of the vehicle-mounted function unit to an external device other than the vehicle-mounted function unit, if the determination unit determines that the vehicle-mounted function unit does not satisfy the requirement.

### [Supplementary Note 3]

A function unit for use in a vehicle-mounted network that includes at least one vehicle-mounted function unit, the function unit including:
a processing circuit,
the processing circuit being configured to
   transmit, to a management device in the vehicle-mounted network, requirement information indicating a requirement for communicating with the vehicle-mounted function unit, in response to the function unit being added to the vehicle-mounted network.

### [Supplementary Note 4]

A management method to be performed in a management device for use in a vehicle-mounted network that includes at least one function unit, the method including:
a step of detecting addition of a function unit to the vehicle-mounted network;
a step of determining whether or not the vehicle-mounted function unit satisfies a requirement for the vehicle-mounted function unit and a new function unit whose addition has been detected to communicate with each other, based on requirement information transmitted from the new function unit and indicating the requirement; and
a step of transmitting, to an external device, update request information requesting updating of the vehicle-mounted function unit, if it is determined that the vehicle-mounted function unit does not satisfy the requirement.

### [Supplementary Note 5]

A communication control method to be used by a function unit for use in a vehicle-mounted network that includes at least one vehicle-mounted function unit, the communication control method including:
a step of transmitting, to a management device in the vehicle-mounted network, requirement information indicating a requirement for communicating with the vehicle-mounted function unit, in response to the function unit being added to the vehicle-mounted network.

### [Supplementary Note 6]

A communication control program for use in a function unit for use in a vehicle-mounted network that includes at least one vehicle-mounted function unit, the communication control program for causing a computer to function as:
a processing unit configured to transmit, to a management device in the vehicle-mounted network, requirement information indicating a requirement for communicating with the vehicle-mounted function unit in response to the function unit being added to the vehicle-mounted network.

### DESCRIPTIONS OF REFERENCE NUMERALS

1 vehicle
11 ethernet cable
51 communication port
101 relay device
111 relay unit
112 detection unit
113 acquisition unit
114 determination unit
115 update request unit
116 generation unit
117 setting unit
118,213 storage unit
161 wireless base station device
170 external network
180 server
202A,202B,202C vehicle-mounted ECU
211 communication unit
212 processing unit
301 vehicle-mounted communication system
401 vehicle-mounted network
501 communication system

1. A management device for use in a vehicle-mounted network that includes at least one vehicle-mounted function unit constituted of a circuitry, the management device comprising:
a detection unit constituted of a circuitry and configured to detect addition of a function unit to the vehicle-mounted network;
a determination unit constituted of a circuitry and configured to determine whether or not the vehicle-mounted function unit satisfies a requirement for the vehicle-mounted function unit and a new function unit being the function unit whose addition has been detected by the detection unit to communicate, based on requirement information transmitted from the new function unit and indicating the requirement; and
an update request unit constituted of a circuitry and configured to transmit update request information requesting updating of the vehicle-mounted function unit to an external device other than the vehicle-mounted function unit, if the determination unit determines that the vehicle-mounted function unit does not satisfy the requirement.

2. The management device according to claim 1, further comprising:
an acquisition unit constituted of a circuitry and configured to acquire, from the vehicle-mounted function unit, function unit information regarding the vehicle-mounted function unit for determining the requirement if the requirement information is received from the new function unit,
wherein the determination unit determines whether or not the vehicle-mounted function unit satisfies the requirement based on the requirement information and the function unit information.

3. The management device according to claim 1, further comprising:
an acquisition unit constituted of a circuitry and configured to acquire, from the external device, function unit information regarding the vehicle-mounted function unit for determining the requirement,
wherein the determination unit determines whether or not the vehicle-mounted function unit satisfies the requirement based on the requirement information and the function unit information.

4. The management device according to claim 1,
wherein the requirement is that a version of software embedded in the vehicle-mounted function unit is the same as a version of software embedded in the new function unit, or that the version of the software embedded in the vehicle-mounted function unit is newer than the version of the software embedded in the new function unit.

5. A function unit constituted of a circuitry and for use in a vehicle-mounted network that includes at least one vehicle-mounted function unit, the function unit comprising:
a processing unit constituted of a circuitry and configured to transmit, to a management device in the vehicle-mounted network, requirement information indicating a requirement for communicating with the vehicle-mounted function unit, in response to the function unit being added to the vehicle-mounted network.

6. A vehicle-mounted communication system comprising:
a management device for use in a vehicle-mounted network that includes at least one vehicle-mounted function unit; and
a function unit constituted of a circuitry,
wherein the management device detects addition of the function unit to the vehicle-mounted network,
a new function unit being the function unit whose addition to the vehicle-mounted network has been detected transmits requirement information to the management device, the requirement information being information indicating a requirement for the vehicle-mounted function unit and the new function unit to communicate,
the management device determines whether or not the vehicle-mounted function unit satisfies the requirement based on the requirement information received from the new function unit, and
if the management device determines that the vehicle-mounted function unit does not satisfy the requirement, the management device transmits update request information requesting updating of the vehicle-mounted function unit to an external device other than the vehicle-mounted function unit.

7. A non-transitory computer readable medium storing a vehicle communication management program to be used by a management device for use in a vehicle-mounted network that includes at least one vehicle-mounted function unit, the vehicle communication management program, when executed by a computer, causing the computer to function as:
a detection unit configured to detect addition of a function unit to the vehicle-mounted network;
a determination unit configured to determine whether or not the vehicle-mounted function unit satisfies a requirement for the vehicle-mounted function unit and a new function unit being the function unit whose addition has been detected by the detection unit to communicate, based on requirement information transmitted from the new function unit and indicating the requirement; and
an update request unit configured to transmit update request information requesting updating of the vehicle-mounted function unit to an external device other than the vehicle-mounted function unit, if the determination unit determines that the vehicle-mounted function unit does not satisfy the requirement.

8. The management device according to claim 2,
wherein the requirement is that a version of software embedded in the vehicle-mounted function unit is the same as a version of software embedded in the new function unit, or that the version of the software embedded in the vehicle-mounted function unit is newer than the version of the software embedded in the new function unit.

9. The management device according to claim 3,
wherein the requirement is that a version of software embedded in the vehicle-mounted function unit is the same as a version of software embedded in the new function unit, or that the version of the software embedded in the vehicle-mounted function unit is newer than the version of the software embedded in the new function unit.
